(19) United States
(12) Patent Application Publication
(10) Pub. No.: US 2020/0385831 A1
(43) Pub. Date: Dec. 10, 2020

(54) A PROCESS FOR REFINING A NITROGEN-CONTAINING METAL ALLOY

(71) Applicant: Sandvik Intellectual Property AB, Sandviken (SE)

(72) Inventor: Bertil WALDÈN, Sandviken (SE)

(73) Assignee: Sandvik Intellectual Property AB, Sandviken (SE)

(21) Appl. No.: 16/955,114

(22) PCT Filed: Dec. 19, 2018
(86) PCT No.: PCT/EP2018/085849

§ 371 Date: Jun. 18, 2020

(30) Foreign Application Priority Data
Dec. 22, 2017 (EP) 17210039.8

(51) Int. Cl. C21D 1/773; C21D 1/767; C21D 6/00; H05B 7/07

(52) U.S. Cl. CPC C21D 1/773; H05B 7/07; C21D 6/002; C21D 1/767

(57) ABSTRACT

A process for refining a nitrogen-containing metal alloy using arc remelting of a consumable electrode in a furnace, comprising: providing a consumable electrode of the metal alloy; providing a second electrode; providing a controlled atmosphere within the furnace; striking an arc between the consumable electrode and the second electrode to melt the consumable electrode and thereby form a molten metal alloy pool; maintaining the arc between the consumable electrode and the molten metal alloy pool; delivering the molten metal alloy into a mould and casting an ingot of refined metal alloy, wherein providing the controlled atmosphere comprises flowing Ar gas through the furnace at an Ar gas pressure of 1-500 Pa.

### TECHNICAL FIELD

The present invention relates to a process for refining a nitrogen-containing metal alloy using arc remelting of a consumable electrode.

### BACKGROUND AND PRIOR ART

Vacuum arc remelting (VAR) is a process used for refining metal alloys in order to achieve better resistance to creep and fatigue. In the VAR process, a consumable electrode of a metal alloy which is to be refined is positioned in a vacuum chamber of a VAR furnace, a second electrode is provided below the consumable electrode, and an arc is struck between the electrodes. The consumable electrode thereby starts to melt and a molten metal alloy pool is formed. The arc is maintained between the consumable electrode and the molten metal alloy pool, the molten metal alloy is delivered into a mould and an ingot of refined metal alloy is cast. U.S. Pat. No. 4,578,795 discloses an example of a VAR process and furnace.

In particular, VAR is used for refining metal alloys that are to be used in e.g. aerospace applications, or in the oil and gas industry, such as stainless steel alloys, superalloys based on iron (Fe), cobalt (Co) or nickel (Ni), and highly alloyed steel alloys. In the VAR process, non-metallic inclusions as well as detrimental elements volatile elements may be removed from the metal alloy. However, in the VAR process, also volatile elements that have a beneficial effect on the metal alloy may be volatilized and lost due to the low pressure within the VAR furnace. For example, a nitrogen (N) content of the metal alloy is typically reduced during the VAR process. In many cases, it is impossible to increase the content of nitrogen in the metal alloy of the consumable electrode without exceeding the nitrogen solubility of the metal alloy and thereby form blisters. Blisters have a negative impact on the VAR process by causing vibrations and instable vacuum pressure in the furnace chamber.

For some alloys, arc remelting is performed with an Ar gas pressure of e.g. 30 kPa within the furnace to reduce the nitrogen loss. However, this has been found to give rise to an unstable arc and substantial vibrations, which limit the size of the ingots that may be produced.

### SUMMARY OF THE INVENTION

It is a primary objective of the present invention to provide a process for refining a nitrogen-containing metal alloy using arc remelting of a consumable electrode, which in at least some aspect alleviates the above-mentioned drawbacks. In particular, it is an objective to provide a process by means of which a reduction of nitrogen content of the metal alloy may be decreased, so that the refined metal alloy may obtain a nitrogen content close to that of the metal alloy before refining.

At least the first objective is achieved by means of the process according to claim 1. Advantageous embodiments of the process are disclosed in the dependent claims.

By flowing Ar gas through the furnace at a relatively low pressure of 1-500 Pa, volatilization of nitrogen (N) is prevented and the reduction of N in the metal alloy during the arc remelting process is thereby decreased. The refined metal alloy may obtain a N content which is close to that of the non-refined metal alloy of the consumable electrode.

The argon (Ar) pressure and the other process parameters, such as arc voltage and electrode gap between the consumable electrode and the molten metal alloy pool, should be such that a stable and diffuse arc is maintained between the consumable electrode and the molten metal alloy pool. The Ar gas pressure should be sufficiently low so that no plasma is created. A plasma may lead to that the arc becomes constricted and thereby stationary, resulting in an undesirable melting of the consumable electrode and an increased nitrogen volatilization. By keeping the Ar gas pressure sufficiently low, the arc is able to quickly scan the consumable electrode surface and thereby the melting process is easier to control.

According to one embodiment, the Ar gas pressure (P_{Ar})>2 Pa. According to another embodiment P_{Ar}≥5 Pa. According to another embodiment P_{Ar}≥10 Pa. According to another embodiment P_{Ar}≥20 Pa, and according to yet another embodiment, P_{Ar}≥50 Pa. The presence of a sufficient Ar gas pressure will guarantee that the technical effect aimed for, namely a significant prevention of volatilization of N in the metal alloy, is achieved.

As mentioned above, the Ar gas pressure should not be too high. According to one embodiment P_{Ar}≤500 Pa. According to one embodiment P_{Ar}≤400 Pa. According to one embodiment P_{Ar}≤300 Pa. According to one embodiment P_{Ar}≤200 Pa.

According to one embodiment the Ar gas pressure is of from 2 to 500 Pa. According to one embodiment, the Ar gas pressure is of from 1-100 Pa. According to another embodiment, the Ar gas pressure is 2-50 Pa, and according to yet another embodiment, the Ar gas pressure isof from 5-50 Pa.

The electrode gap may preferably be within the range of 5-15 mm, more preferably 7-12 mm, and even more preferably 8-10 mm.

A mean arc voltage used to maintain the arc may be within the range of 20-25 V.

According to one embodiment, the process comprises controlling the electrode gap by means of drop-short control. By drop-short control is herein intended a process in which the electrode gap is controlled by maintaining a drop-short set-point, i.e. a drop-short frequency or a drop-short period. Drop-short control facilitates controlling the electrode gap. For example, the drop-short frequency may be set to 0.5-10 s⁻¹, such as 1-4 s⁻¹. The electrode gap may alternatively be controlled using voltage control, i.e. by maintaining a voltage set-point.

According to one embodiment, the method comprises establishing a stable flow of Ar gas through the furnace prior to striking the arc. Stable may in this regard be referred to as only fluctuating within the defined Ar gas pressure range, or within a predefined subrange thereof. This will improve the conditions for striking and maintaining a stable and diffuse arc and obtaining a stable melt rate.

According to one embodiment, flowing Ar gas through the furnace comprises continuously flowing Ar gas at a constant or at an essentially constant Ar gas pressure. By “essentially constant” is herein intended to mean that the Ar gas pressure is not allowed to deviate by more than ±10% from a desired Ar gas pressure value. By maintaining a constant or essentially constant Ar gas pressure during melting, oscillations that may lead to an unstable arc are prevented.

The metal alloy may be a stainless steel alloy, a superalloy based on iron (Fe), cobalt (Co) or nickel (Ni), or a highly alloyed steel alloy. In particular, the metal alloy may be a metal alloy having a nitrogen content of at least 0.001-0.20 percent by weight (wt. %), preferably 0.025-0.10 wt. %. The process is particularly useful for metal alloys in which the nitrogen is dissolved in the metal alloy, since dissolved nitrogen is more likely to dissipate during VAR than nitrogen tied up in metal nitrides.

Further advantages as well as advantageous features of the present invention will appear from the following detailed description.

### BRIEF DESCRIPTION OF THE DRAWINGS

Embodiments of the invention will in the following be further described by means of example with reference to the appended drawings, wherein

FIG. 1 is a flow chart showing a process according to an embodiment of the invention.

### DETAILED DESCRIPTION OF EMBODIMENTS OF THE INVENTION

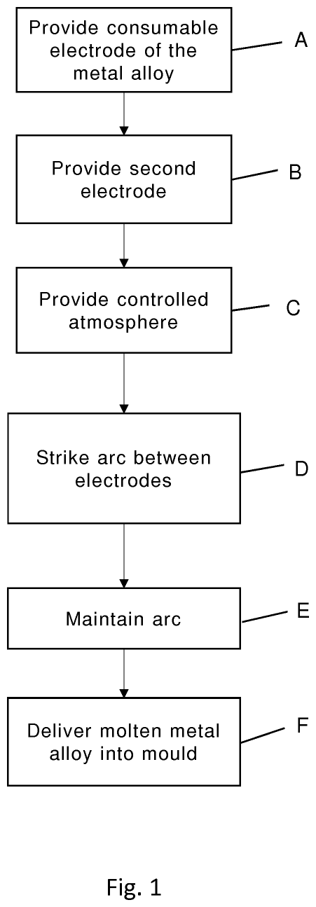

A process for refining a nitrogen-containing metal alloy using arc remelting of a consumable electrode in a furnace according to an embodiment of the invention is schematically illustrated in the flow chart in FIG. 1. The method comprises the following steps:

A: providing a consumable electrode of the metal alloy;

B: providing a second electrode;

C: providing a controlled atmosphere within the furnace, comprising flowing Ar gas through the furnace at an Ar gas pressure of 1-500 Pa;

D: striking an arc between the consumable electrode and the second electrode to melt the consumable electrode and thereby form a molten metal alloy pool;

E: maintaining the arc between the consumable electrode and the molten metal alloy pool; and

F: delivering the molten metal alloy into a mould and casting an ingot of refined metal alloy.

The consumable electrode, consisting of the metal alloy which is to be refined, may e.g. be of a stainless steel alloy, a superalloy based on iron (Fe), cobalt (Co) or nickel (Ni), or a highly alloyed steel alloy. The metal alloy may have a nitrogen content of at least 0.001-0.20 percent by weight (wt. %), such as 0.025-0.10 wt. %. The consumable electrode may be cylindrical.

The consumable electrode is positioned within a cooled crucible in a furnace chamber of a VAR furnace, e.g. a water-cooled crucible surrounded by a water jacket. An inner diameter of the crucible is larger than the diameter of the consumable electrode. A drive mechanism is used for controlling the position of the consumable electrode within the furnace and is used to lower the consumable electrode as it is being melted.

The second electrode may according to one embodiment comprise the same metal alloy as the consumable electrode, but it may according to another embodiment be formed from a different metal alloy, since a portion of the formed ingot comprising the metal alloy from the second electrode may easily be parted from the remaining ingot of the refined metal alloy. The second electrode is positioned below the consumable electrode within the cooled crucible. A gap is formed between the electrodes, which gap may be controlled using the drive mechanism.

The Ar gas pressure may be as low as 1 Pa, butmay according to other embodiments be at least 2 Pa or at least 5 Pa. The Ar gas pressure may be up to 500 Pa, but is may be limited to a maximum of 100 Pa or 50 Pa. The Ar gas may enter into the furnace at a position above the second electrode, such that Ar gas is flown over the molten metal alloy pool when the arc is struck. A stable

Ar gas pressure is preferably established before striking the arc. The Ar gas pressure is preferably maintained constant or essentially constant during the arc remelting process by continuously flowing Ar gas over the molten metal alloy pool, thereby contributing to keeping the arc stable.

The arc may be struck by passing a current through the consumable electrode. A negative voltage is applied to the consumable electrode while maintaining the second electrode at ground potential. Voltage, current and/or electrode gap may be controlled to maintain a stable a diffuse arc. According to one embodiment, the electrode gap is controlled by means of drop-short control, i.e. by controlling the electrode gap based on a desired detected rate of drop-shorts. Such a drop-short control is described in e.g. U.S. Pat. No. 4,578,795.

The cooled crucible in which the electrodes are positioned forms the mould in which the molten metal alloy is solidified so that an ingot is cast. The cast ingot therefore has a larger diameter than the consumable electrode.

### EXAMPLE 1

Two consumable electrodes with a diameter of 400 mm were made of a test alloy with an elemental composition corresponding to standard UNS N06985, i.e. a stabilized austenitic NiCrFe alloy with a relatively high Mo content and with an addition of Co and Cu. Before remelting, the test alloy contained 0.037 percent by weight (wt. %) of N.

A first one of the consumable electrodes was remelted using VAR in vacuum, i.e. without flowing Ar over the molten metal alloy pool. The pressure within the furnace was around 0.15 Pa. A stable melt rate was achieved using drop-short control (3.5 s⁻¹) with a current of 9 kA, a voltage of 20-21 V and a melt rate of 6 kg/min.

A second one of the consumable electrodes was remelted using arc remelting with Ar flowing over the molten metal alloy pool. During the remelting process, the Ar gas pressure was varied and allowed to stabilize at different levels. It was noted that the arc became unstable as the Ar gas pressure was increased above 200 Pa (decreasing melt rate) and that plasma was generated at an Ar gas pressure of 10 kPa, leading to a rapid increase in the drop-short frequency.

Samples from the received ingots of remelted test alloy were taken at positions corresponding to various Ar gas pressures in the furnace and analysed with regard to elemental composition. Results of the analysis with regard to N content are shown in Table I. As can be seen, it was found that Ar gas pressures of 5 Pa and 170 Pa appear to be particularly beneficial for maintaining a similar N content as before remelting. Other alloying elements of the test alloy were not significantly affected by the remelting process.

TABLE I

| | | | | |
|---|---|---|---|---|
| Ar gas pressure (kPa) | 0 | 0.005 | 0.17 | 10 |
| N content (wt. %) | 0.017 | 0.035 | 0.035 | 0.025 |

### EXAMPLE 2

A consumable electrode was formed from a test alloy with a composition according to Sanicro 28 (standard UNS N08028), i.e. an austenitic NiCrFe alloy with an addition of Mo, Mn and Cu. Before remelting, the test alloy contained 0.085 wt. % of N.

The consumable electrode was remelted using arc remelting with Ar flowing over the molten metal alloy pool at a stable Ar gas pressure of 5 Pa. A stable melt rate of 4.8 kg/min was achieved using drop-short control (3 s⁻¹) with a current of 7.5 kA and a voltage of 22.2 V. A second stable melt rate of 7.5 kg/min was achieved using drop-short control (1.5 s⁻¹) with a current of 10.5 kA and a voltage of 22.5 V.

After remelting, a sample was taken from the remelted ingot and analysed with regard to elemental composition. It was found that the N content had decreased from 0.085 wt. % to 0.077 wt. %, i.e. a reduction of 9%. In comparison, during remelting of a corresponding alloy in vacuum, the N content decreased from 0.096 wt. % to 0.080 wt. %, i.e. a reduction of 17%.

The invention is of course not in any way restricted to the embodiments described above, but many possibilities to modifications thereof would be apparent to a person with skill in the art without departing from the scope of the invention as defined in the appended claims.

1. A process for refining a nitrogen-containing metal alloy using arc remelting of a consumable electrode in a furnace, comprising:
providing a consumable electrode of the metal alloy;
providing a second electrode;
providing a controlled atmosphere within the furnace;
striking an arc between the consumable electrode and the second electrode to melt the consumable electrode and thereby form a molten metal alloy pool;
maintaining the arc between the consumable electrode and the molten metal alloy pool; and
delivering the molten metal alloy into a mould and casting an ingot of refined metal alloy,
wherein providing the controlled atmosphere comprises flowing Ar gas through the furnace at an Ar gas pressure of 1-500 Pa.

2. The process according to claim 1, wherein the Ar gas pressure is from 2 to 500 Pa.

3. The process according to claim 1, wherein the Ar gas pressure is 1-100 Pa.

4. The process according to claim 1, wherein an electrode gap between the consumable electrode and the molten metal alloy pool is controlled such that the arc is maintained stable and diffuse.

5. The process according to claim 4, wherein the electrode gap is within the range of 5-15 mm.

6. The process according to claim 5, comprising controlling the electrode gap by means of drop-short control.

7. The process according to claim 1, comprising establishing a stable flow of Ar gas through the furnace prior to striking the arc.

8. The process according to claim 1, wherein flowing Ar gas through the furnace comprises continuously flowing Ar gas at a constant or at an essentially constant Ar gas pressure.

9. The process according to claim 1, wherein a mean arc voltage used to maintain the arc is within the range of 20-25 V.

10. The process according to claim 1, wherein the metal alloy is a stainless steel alloy, a superalloy or a highly alloyed steel alloy.

11. The process according to claim 1, wherein the metal alloy has a nitrogen content of at least 0.001-0.20 percent by weight (wt. %).

12. The process according to claim 11, wherein the nitrogen content is 0.025 to 0.10 percent by weight (wt. %).

13. The process according to claim 3, wherein the Ar gas pressure is 2-50 Pa.

14. The process according to claim 13, wherein the Ar gas pressure is 5-50 Pa.

15. The process according to claim 4, comprising controlling the electrode gap by means of drop-short control.

16. The process according to claim 4, wherein the electrode gap is within the range of 7-12 mm.

17. The process according to claim 4, wherein the electrode gap is within the range of 8-10 mm.
